(19) United States
(12) Patent Application Publication
(10) Pub. No.: US 2022/0212383 A1
(43) Pub. Date: Jul. 7, 2022

(54) MANUFACTURING METHOD AND INJECTION MOLDING SYSTEM

(71) Applicant: Canon Virginia, Inc., Newport News, VA (US)

(72) Inventor: Koki KODAIRA, Tokyo (JP)

(21) Appl. No.: 17/611,503

(22) PCT Filed: May 13, 2020
(86) PCT No.: PCT/US20/32737

§ 371 Date: Nov. 15, 2021

Related U.S. Application Data
(60) Provisional application No. 62/849,693, filed on May 17, 2019.

(51) Int. Cl. B29C 45/17; B29C 45/73; B29C 45/04

(52) U.S. Cl. CPC B29C 45/1756; B29C 45/0416; B29C 45/73; B29C 45/1742

(57) ABSTRACT

A method for manufacturing a molded part with an injection molding machine and a conveying apparatus while changing between multiple molds, the method including conveying a first mold to a molding operation position in the injection molding machine, securing the first mold at the molding operation position with a platen, fixing the platen to the first mold, opening the first mold, ejecting a molded part from the first mold, placing the first mold into a state where the first mold is slightly opened, injecting a molding material into the first mold, applying pressure to the first mold by closing the slight opening of the first mold, releasing the platen from the first mold, conveying the first mold from the molding operation position to the conveying apparatus, and cooling the first mold on the conveying apparatus.

### CROSS-REFERENCE to RELATED APPLICATION

This application claims the benefit of U.S. Provisional Application 62/849,693, which was filed on May 17, 2019.

### FIELD

The present disclosure relates to an injection molding system.

### BACKGROUND

Manufacturing of molded parts by an injection molding machine includes injecting a resin into a mold after clamping the mold, pressing the resin into the mold at a high pressure in order to compensate for a volume decrease due to solidification of the resin, keeping the molded part in the mold until the resin solidifies, and ejecting the molded part from the mold.

In the above-described molding approach, a method that uses two molds with one injection molding machine in order to enhance productivity has been proposed. For example, US 2018/0009146/Japanese patent publication No. 2018-001738/VN20160002505 are seen to discuss a system in which conveying devices 3A and 3B are arranged on both sides of an injection molding machine 2. In this system, molded parts are manufactured while alternating a plurality of molds by the conveying devices 3A and 3B for the one injection molding machine 2. FIGS. 1-4 illustrate an injection molding system of US 2018/0009146/Japanese patent publication No. 2018-001738/VN20160002505.

In this system, cooling of the molds 100A or 100B is performed on the conveying machines 3A or 3B outside of the injection molding machine 2. During cooling of one of the molds 100A/100B, each process of molded part ejection→clamping→injection/dwelling is performed by the injection molding machine 2 for the other mold 100A/100B. Since opening and molded part ejection are performed by the injection molding machine 2, the conveying machines 3A and 3B do not need a function for opening and a function for molded part ejection.

This enables manufacture of the molded part P while alternating the plurality of the molds by the one injection molding machine 2. This can reduce the overall cost of the system.

If the time required for all processes from the start of the mold replacement process, to the other mold ejecting process, injection process, and dwelling process, and up until completion of the mold replacement process once again fits into the time required for cooling one of the molds, then productivity compared to normal molding is improved by a maximum of two times. That is, in addition to suppressing cost increases, there is the merit that it is possible to realize high productivity.

A compression molding technique is known. In this technique, the mold is slightly opened in advance to an injection molding. After the resin is injected into the mold, the mold is closed and the resin is compressed. According to the technique, uniform pressure can be applied, which enables production of molded parts with less warpage than standard injection molding techniques.

What is needed is an ability to perform compression molding while alternating (changing) multiple molds.

### SUMMARY

A method for manufacturing a molded part with an injection molding machine and a conveying apparatus while changing between multiple molds, the method comprising conveying a first mold to a molding operation position in the injection molding machine, securing the first mold at the molding operation position with a platen, fixing the platen to the first mold, opening the first mold, ejecting a molded part from the first mold, placing the first mold into a state where the first mold is slightly opened, injecting a molding material into the first mold, applying pressure to the first mold by closing the slight opening of the first mold, releasing the platen from the first mold, conveying the first mold from the molding operation position to the conveying apparatus, and cooling the first mold on the conveying apparatus.

This and other embodiments, features, and advantages of the present disclosure will become apparent upon reading the following detailed description of exemplary embodiments of the present disclosure, when taken in conjunction with the appended drawings, and provided claims.

### BRIEF DESCRIPTION OF DRAWINGS

FIG. 1 illustrates an injection molding system.

FIG. 2 is a side view of the injection molding machine.

FIG. 3 is an end view of a fixed platen, and a figure viewing from the arrow direction of the I-I line in FIG. 2.

FIG. 4 is a partial perspective view illustrating the configuration of a periphery of the molding operation position.

FIG. 5 illustrates flowcharts of a standard molding process and a compression molding process.

FIG. 6 is a flowchart illustrating an example of processing of a molding operation while alternating molds.

FIGS. 7A and 7B illustrate a length of a gap between a mold and a platen.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF EXEMPLARY EMBODIMENTS

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

With reference to the drawings, the arrow symbols X and Y in each Figure indicate horizontal directions that are orthogonal to each other, and the arrow symbol Z indicates a vertical (upright) direction with respect to the ground.

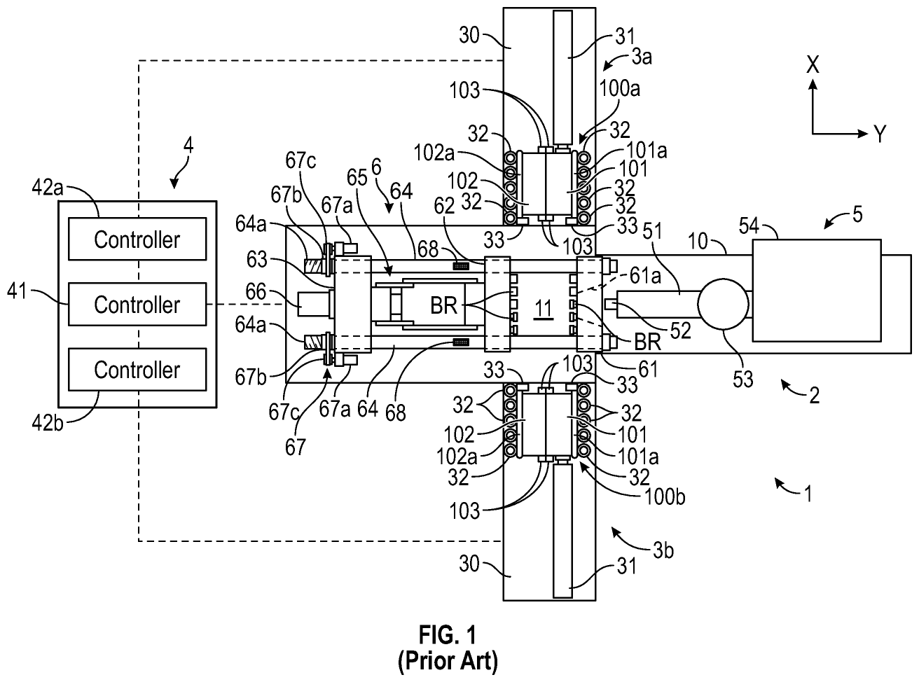

FIGS. 1-4 illustrate injection molding system 1 of US 2018/0009146/Japanese patent publication No. 2018-001738/VN20160002505 and are being provided herein for information/description purposes only.

The injection molding system 1 includes an injection molding machine 2, conveying machines 3A and 3B, and a control apparatus 4. The injection molding system 1 manufactures a molded part while alternating a plurality of molds using the conveying machines 3A and 3B for the one injection molding machine 2. Two molds, 100A and 100B are used.

The mold 100A/100B is a pair of a fixed mold 101 and a movable mold 102, which is opened/closed in relation to the fixed mold 101. The molded part is molded by injecting a molten resin into a cavity formed between the fixed mold 101 and the movable mold 102. Clamping plates 101a and 102a are respectively fixed to the fixed mold 101 and the movable mold 102. The clamping plates 101a and 102a are used to lock the mold 100A/100B to a molding operation position 11 (mold clamping position) of the injection molding machine.

For the mold 100A/100B, a self-closing unit 103 is provided for maintaining a closed state between the fixed mold 101 and the movable mold 102. The self-closing unit 103 enables preventing the mold 100A/100B from opening after unloading the mold 100A/100B from the injection molding machine 2. The self-closing unit 103 maintains the mold 100A/100B in a closed state using a magnetic force. The self-closing unit 103 located at a plurality of locations along opposing surfaces of the fixed mold 101 and the movable mold 102. The self-closing unit 103 is a combination of an element on the side of the fixed mold 101 and an element on the side of the movable mold 102. For the self-closing unit 103, typically two or more pair are installed for one of the molds 100A and 100B.

A conveying machine 3A loads and unloads the mold 100A onto/from the molding operation position 11 of the injection molding machine 2. A conveying machine 3B loads and unloads the mold 100B onto/from the molding operation position 11. The conveying machine 3A, the injection molding machine 2, and the conveying machine 3B are arranged to be lined up in this order in the X-axis direction. In other words, the conveying machine 3A and the conveying machine 3B are arranged laterally with respect to the injection molding machine 2 to sandwich the injection molding machine 2 in the X-axis direction. The conveying machines 3A and 3B are arranged to face each other, and the conveying machine 3A is arranged on one side laterally of the injection molding machine 2, and the conveying machine 3B is arranged on the other side respectively adjacent. The molding operation position 11 is positioned between the conveying machine 3A and the conveying machine 3B. The conveying machines 3A and 3B respectively include a frame 30, a conveyance unit 31, a plurality of rollers 32, and a plurality of rollers 33.

The frame 30 is a skeleton of the conveying machine 3A and 3B, and supports the conveyance unit 31, and the pluralities of rollers 32 and 33. The conveyance unit 31 is an apparatus that moves the mold 100A/100B back and forth in the X-axis direction, and that removes and inserts the mold 100A/100B in relation to the molding operation position 11.

The conveyance unit 31 is an electrically driven cylinder with a motor as a driving source, and includes a rod that moves forward/backward in relation to the cylinder. The cylinder is fixed to the frame 30, and the fixed mold 101 is fixed to the edge portion of the rod. For the conveyance unit 31 both a fluid actuator and an electric actuator can be used, where the electric actuator can provide better precision of control of the position or the speed when conveying the mold 100A/100B. The fluid actuator can be an oil hydraulic cylinder, or an air cylinder, for example. The electric actuator can, in addition to an electrically driven cylinder, be a rack-and-pinion mechanism with a motor as the driving source, a ball screw mechanism with a motor as the driving source, or the like.

The conveyance unit 31 is arranged independently for each of the conveying machines 3A and 3B. However, a common support member that supports the molds 100A and 100B can be used, and a single common conveyance unit 31 can be arranged for this support member. A case where the conveyance unit 31 is arranged independently for each of the conveying machines 3A and 3B enables handling cases where a movement strokes differ between the mold 100A and the mold 100B when conveying. For example, a case in which molds cannot be conveyed simultaneously since the widths of the molds (the width in the X direction) differ or the thickness of the molds (the width in the Y direction) differ.

The plurality rollers 32 configure a row of rollers arranged in the X-axis direction, where two rows are configured separated in the Y-axis direction. The plurality of rollers 32 rotate around the axis of revolution in the Z-axis direction, and guide movement in the X-axis direction of the mold 100A/100B contacting the side surfaces of the mold 100A/100B (the side surfaces of the clamping plates 101a and 102a) and supporting the mold 100A/100B from the side. The plurality rollers 33 configure a row of rollers arranged in the X-axis direction, where two rows are configured separated in the Y-axis direction. The plurality of rollers 33 rotate around the axis of revolution in the Y direction, and cause movement in the X direction of the mold 100A/100B to be smooth, supporting the bottom surfaces of the mold 100A/100B (the bottom surfaces of the clamping plates 101a and 102a) and supporting the mold 100A/100B from below.

The control apparatus 4 includes a controller 41 for controlling the injection molding machine 2, a controller 42A for controlling the conveying machine 3A, and a controller 42B for controlling the conveying machine 3B. Each of the controllers 41, 42A and 42B includes, for example, a processor such as a CPU, a RAM, a ROM, a storage device such as a hard disk, and interfaces connected to sensors or actuators (not illustrated). The processor executes programs stored in the storage device. An example of a program (control) that the controller 41 executes is described below. The controller 41 is communicably connected with the controllers 42A and 42B, and provides instructions related to the conveyance of the mold 100A/100B to the controllers 42A and 42B. The controllers 42A and 42B, if loading and unloading of the mold 100A/100B terminates, transmit a signal for operation completion to the controller 41. In addition, the controllers 42A and 42B transmit an emergency stop signal at a time of an abnormal occurrence to the controller 41.

A controller is arranged for each of the injection molding machine 2, the conveying machine 3A, and the conveying machine 3B, but one controller can control all three machines. The conveying machine 3A and the conveying machine 3B can be controlled by a single controller for more reliable and collaborative operation.

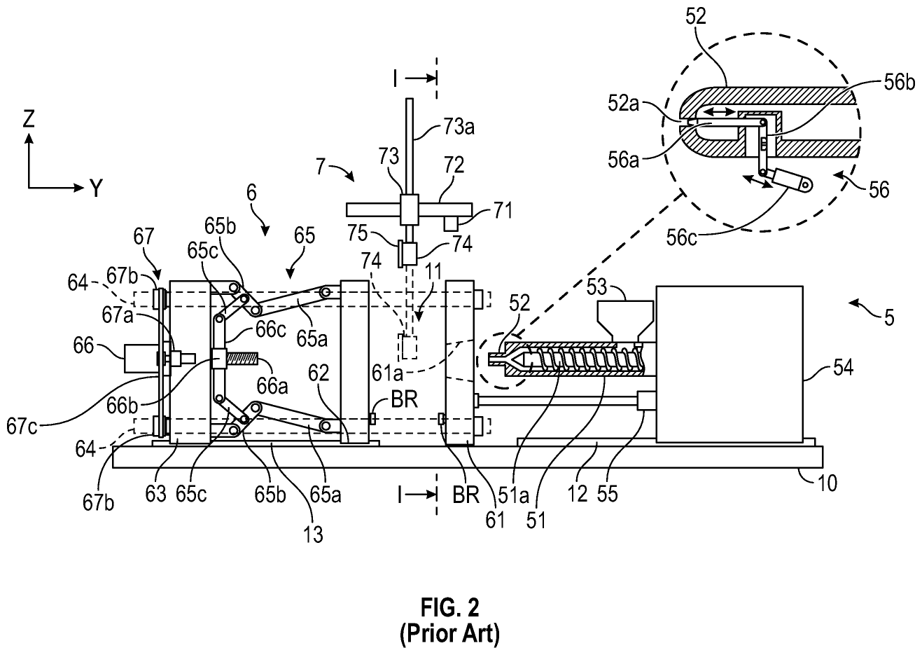

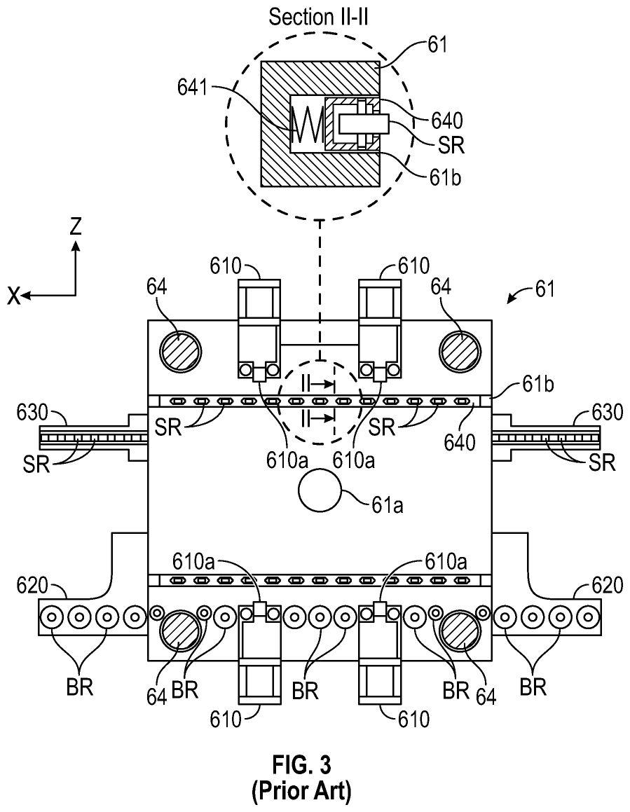

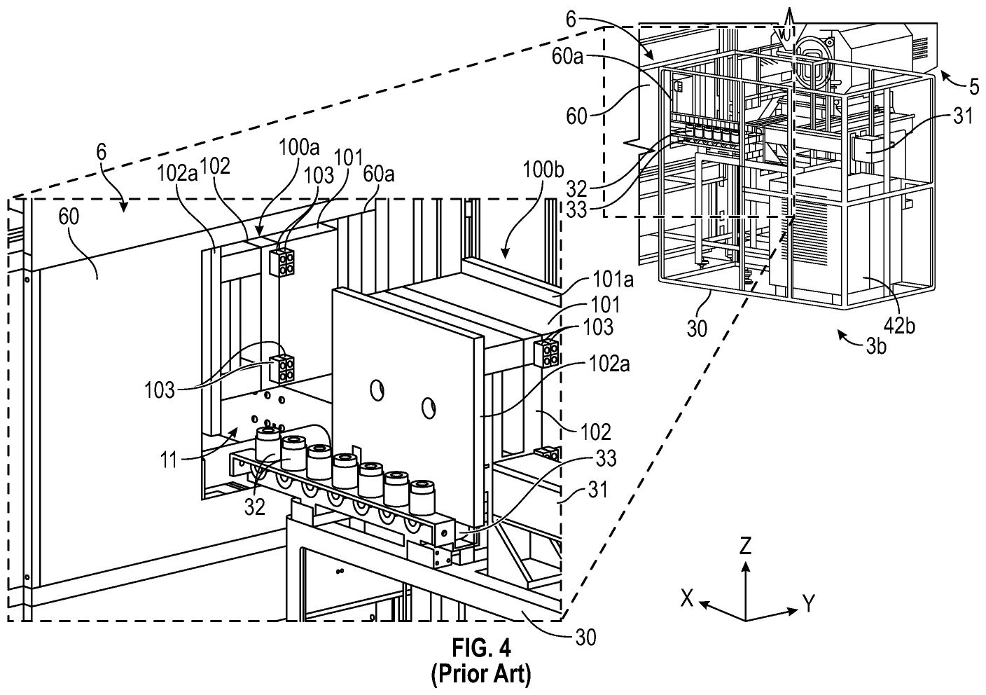

FIG. 2 illustrates a side view of the injection molding machine 2. FIG. 3 illustrates an end view of a fixed platen 61, and a figure viewing from the arrow direction of the I-I line in FIG. 2. FIG. 4 illustrates a partial perspective view for describing the configuration of a periphery of the molding operation position 11.

With reference to FIG. 1 and FIG. 2, the injection molding machine 2 includes an injecting apparatus 5, a clamping apparatus 6, and a take-out robot 7 for ejecting a molded part. The injecting apparatus 5 and the clamping apparatus 6 are arranged on a frame 10 in the Y-axis direction.

The injecting apparatus 5 includes an injection cylinder 51 that is arranged to extend in the Y-axis direction. The injection cylinder 51 includes a heating device (not illustrated) such as a band heater, and melts a resin introduced from a hopper 53. A screw 51a is integrated into the injection cylinder 51, and by rotation of the screw 51a, plasticizing and measuring the resin introduced into the injection cylinder 51 are performed, and by movement in the axial direction (Y-axis direction) of the screw 51a, it is possible to inject a molten resin from an injection nozzle 52.

In FIG. 2, an example of a shut-off nozzle as the nozzle 52 is illustrated. For an opening/closing mechanism 56 of FIG. 2, a pin 56a for opening/closing the discharge port 52a is arranged. The pin 56a is connected with an actuator (a cylinder) 56c via a link 56b, and by the operation of the actuator 56c the discharge port 52a is opened and closed.

The injection cylinder 51 is supported by a driving unit 54. In the driving unit 54, a motor for plasticizing and measuring the resin by rotationally drive the screw 51a, and a motor for driving the screw 51a to move forward/backward in the axial direction are arranged. The driving unit 54 can move forward/backward in the Y-axis direction along a rail 12 on the frame 10, and in the driving unit 54, an actuator (for example, an electrically driven cylinder) 55 for causing the injecting apparatus 5 to move forward/backward in the Y-axis direction is arranged.

The clamping apparatus 6 performs a clamping and opening and closing of the molds 100A/100B. In the clamping apparatus 6, the following are arranged in order in the Y-axis direction: the fixed platen 61, a movable platen 62, and a movable platen 63. Through platens 61 to 63, a plurality of tie-bars 64 pass. Each of the tie-bars 64 is an axis that extends in the Y-axis direction, one end of which is fixed to the fixed platen 61. Each of the tie-bars 64 is inserted into a respective through hole formed in the movable platen 62. The other end of each of the tie-bars 64 is fixed to the movable platen 63 through an adjusting mechanism 67. The movable platens 62 and 63 can move in the Y-axis direction along a rail 13 on the frame 10, and the fixed platen 61 is fixed to the frame 10.

A toggle mechanism 65 is arranged between the movable platen 62 and the movable platen 63. The toggle mechanism 65 causes the movable platen 62 to move forward/backward in the Y-axis direction in relation to the movable platen 63 (in other words, in relation to the fixed platen 61). The toggle mechanism 65 includes links 65a to 65c. The link 65a is connected rotatably to the movable platen 62. The link 65b is pivotably connected to the movable platen 63. The link 65a and the link 65b are pivotably connected to each other. The link 65c and the link 65b are pivotably connected to each other. The link 65c is pivotably connected to an arm 66c.

The arm 66c is fixed on a ball nut 66b. The ball nut 66b engages a ball screw shaft 66a that extends in the Y-axis direction, and moves forward/backward in the Y-axis direction by rotation of the ball screw shaft 66a. The ball screw shaft 66a is supported such that it is free to rotate by the movable platen 63, and a motor 66 is supported by the movable platen 63. The motor 66 rotationally drives the ball screw shaft 66a while the rotation amount of the motor 66 is detected. Driving the motor 66 while detecting the rotation amount of the motor 66 enables clamping, opening, and closing of the mold 100A/100B.

The injection molding machine 2 includes sensors 68 for measuring a clamping force, where each sensor 68 is, for example, a strain gauge provided on the tie-bar 64, and calculates a clamping force by detecting a distortion of the tie-bar 64.

The adjusting mechanism 67 includes nuts 67b supported to freely rotate on the movable platen 63, motors 67a as driving sources, and transfer mechanisms for transferring the driving force of the motors 67a to the nuts 67b. Each of the tie-bars 64 passes through a hole formed in the movable platen 63, and engages with the nut 67b. By causing the nuts 67b to rotate, the engagement positions in the Y-axis direction between the nuts 67b and the tie-bars 64 change. That is, the position at which the movable platen 63 is fixed in relation to the tie-bar 64 changes. With this, it is possible to cause a space between the movable platen 63 and the fixed platen 61 to change, and thereby it is possible to adjust a clamping force or the like.

The molding operation position 11 is a region between the fixed platen 61 and the movable platen 62.

The mold 100A/100B introduced into the molding operation position 11 are sandwiched between the fixed platen 61 and the movable platen 62 and thereby clamped. Opening and closing in based on movement of the movable mold 102 by movement of the movable platen 62 is performed.

FIG. 3 illustrates an opening portion 61a in a central portion of the fixed platen 61 through which the nozzle 52 moves forward/backward. To the surface on the side of the movable platen 62 (called an inner surface) of the fixed platen 61 a plurality of rollers BR are supported such that they are free to rotate. The plurality of rollers BR rotate around the axis of revolution in the Y-axis direction, and cause movement in the X-axis direction of the mold 100A/100B to be smooth, supporting the bottom surfaces (the bottom surface of the clamping plate 101a) of the mold 100A/100B and supporting the mold 100A/100B from below. On both sides in the X-axis direction of the fixed platen 61, a roller supporting body 620 is fixed, and the plurality of rollers BR are supported by the roller supporting body 620.

On the inner surface of the fixed platen 61, grooves 61b that extend in the X-axis direction are formed.

The grooves 61b are formed in two rows separated vertically. On each of the grooves 61b a roller unit 640 is arranged. For the roller unit 640, a plurality of rollers SR are supported such that they are free to rotate. The plurality of rollers SR rotate around the axis of revolution in the Z-axis direction, and guide movement in the X-axis direction of the mold 100A/100B contacting the outer surfaces of the mold 100A/100B (the outer surface of the clamping plate 101a) and supporting the mold 100A/100B from the side. As illustrated in the cross sectional view of the line II-II, while the roller unit 640, by a bias of a spring 641, is positioned at a position at which the roller SR protrudes from the groove 61b, at a time of clamping it is retracted in the groove 61b, and positioned at a position at which the roller SR does not protrude from the groove 61b. The roller unit 640 can prevent the inner surfaces of the mold 100A/100B and the fixed platen 61 from contacting and damaging the inner surfaces at a time of alternating the mold 100A/100B, and the roller unit 640 does not impede the inner surface of the fixed platen 61 and the mold 100A/100B being closed at a time of clamping.

On both sides in the X-axis direction of the fixed platen 61, a roller supporting body 630 is fixed, and a plurality of rollers SR are supported by the roller supporting body 630.

On the fixed platen 61, a plurality of fixing mechanisms (clamps) 610 are arranged for fixing the fixed mold 101 to the fixed platen 61. Each fixing mechanism 610 includes an engaging portion 610a that engages with the clamping plate 101a, and a built-in actuator (not illustrated) that moves the engaging portion 610a between an engagement position and an engagement release position.

Note that for the movable platen 62, similarly to the fixed platen 61, a plurality of rollers BR, the roller supporting bodies 620 and 630, the roller unit 640, and the fixing mechanism 610 for fixing the movable mold 102 are arranged.

As illustrated in FIG. 4, the periphery of the clamping apparatus 6 is surrounded by a cover (exterior covering plate) 60 for safety, but openings 60a through which the mold 100A/100B pass are formed on the sides of the molding operation position 11 for alternating the mold 100A/100B. Each opening 60a is typically continuously open, enabling free removal and insertion of the mold 100A/100B from and to the molding operation position 11.

Returning to FIG. 2, the take-out robot 7 will now be described. The take-out robot 7 includes a rail 71 that extends in the X-axis direction, and a movable rail 72 that can move in the X-axis direction on the rail 71. The movable rail 72 is arranged to extend in the Y-axis direction, and a slider 73 is arranged on the movable rail 72. The slider 73 moves in the Y-axis direction guided by the movable rail 72, and moves up and down an elevating shaft 73a in the Z-axis direction. On a lower end of the elevating shaft 73a, a vacuum head 74 is arranged, and on the vacuum head 74, a chuck plate 75 specialized to a molded part is mounted.

The take-out robot 7, after opening, moves the vacuum head 74 between the fixed mold 101 and the movable mold 102 as illustrated by broken lines in FIG. 2 by the rail 71, the movable rail 7, and the slider 73, sticks to the molded part, and conveys it outside the mold 100A/100B.

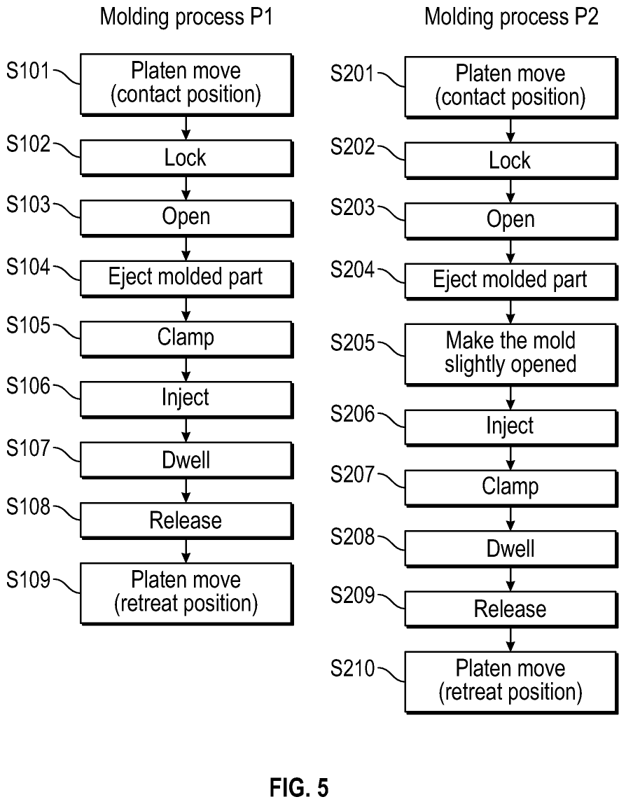

FIG. 5 illustrates examples of operation of the injection molding system 1. Molding Process P1 illustrates a standard molding process while Molding Process P2 illustrates a compression molding process.

In the Molding Process P1, the fixed platen 61 and moveable platen 62 automatically close and contact with the mold 100A/100B in response to the mold 100A/100B being conveyed to molding operation position 11.

In the step S101, the fixed platen 61 and moveable platen 62 move to a contact position where they contact with the mold 100A/100B. The fixed platen 61 and moveable platen 62 secure the mold 100A/100B. In step S102, the mold 100A/100B is locked (fixed) to both the fixed platen 61 and the movable platen 62 by driving the fixing mechanisms 610. In step S103, the movable platen 62 is separated from the fixed platen 61 by driving the motor 66. The fixed mold 101 is fixed to the fixed platen 61 by the fixing mechanisms 610, and the movable mold 102 is fixed to the movable platen 62 by the fixing mechanisms 610. The movable mold 102 separates from the fixed mold 101 and the mold 100A/100B is opened against a force, e.g., magnetic, of the self-closing unit 103.

The molded part remaining on the side of the movable mold 102 of the mold 100A/100B is removed by driving the take-out robot 7 in step S104, and conveyed outside of the injection molding machine 2. The vacuum head 74 is moved to a position where the chuck plate 75 faces the molded part P, and the molded part P is secured by suction.

In step S105, clamping of the mold 100A/100B by the fixed platen 61 and the movable platen 62 is performed by driving the motor 66 to drive the toggle mechanism 65. In step S106, injection of molten resin is performed.

In step S107, dwelling of the molten resin is performed. More specifically, the injecting apparatus 5 is driven to fill molten resin into a cavity in the mold 100A/100B from the nozzle 52, and to press the resin in the cylinder 51 into the mold 100A/100B at a high pressure to compensate for a volume decrease due to resin solidifying.

In step S108, locking of the mold 100A/100B by the fixing mechanism 610 is released. This results in removal of the clamping force, and the movable platen 62 is slightly separated from the fixed platen 61. In step S109, after a delay of a predetermined time from step S108, the motor 66 is driven to drive the toggle mechanism 65. That is, the fixed platen 61 and the moveable platen 62 move to a retreat position where they do not contact with the mold 100A/100B. These movements result in a space forming between the fixed platen 61 and the moveable platen 62 for alternating (changing) the molds 100A and 100B.

After step S109, the mold 100A/100B is ejected from the molding operation position 11 to the conveying machine 3A/3B, where the mold 100A/100B is cooled to an appropriate temperature during a predetermined time period. A mold typically includes a channel running inside the mold. An external temperature controller is connected, via a hose, to an interface of the channel formed on a surface of the mold while the mold is prepared for injection molding. A fluid at a predetermined temperature flows from the temperature controller inside the mold to keep the mold at a predetermined temperature. During the injection molding processes, including the cooling process, fluid typically flows inside the mold.

After step S108, the mold is typically still heated up from the melted resin injected into the mold 100A/100B. In the cooling process, the fluid from the temperature controller causes the temperature to drop to a predetermined temperature, e.g., 60 degrees Celsius. The cooling process continues until a predetermined time period passes from the start of the cooling process.

In some injection molding processes, like heat and cool molding, the cooling process includes a dedicated temperature controller to cool down a mold to a certain temperature, which is different from a temperature at which the mold receives the melted resin from an injecting machine.

Turning to Molding Process P2, the fixed platen 61 and moveable platen 62 automatically close and they contact with the mold 100A/100B in response to the mold 100A/100B being conveyed to molding operation position 11.

In step S201, the fixed platen 61 and moveable platen 62 move to a contact position where they contact the mold 100A/100B. The fixed platen 61 and moveable platen 62 secure the mold 100A/100B. In step S202, the mold 100A/100B is locked (fixed) to both the fixed platen 61 and the movable platen 62 by driving the fixing mechanisms 610. In step S203, the movable platen 62 is separated from the fixed platen 61 by driving the motor 66.

The fixed mold 101 is fixed to the fixed platen 61 and the movable mold 102 is fixed to the movable platen 62 by the fixing mechanisms 610. The movable mold 102 separates from the fixed mold 101 and the mold 100A/100B is opened against a force, e.g., magnetic, of the self-closing unit 103. The molded part remaining on the side of the movable mold 102 of the mold 100A/100B is removed by driving the take-out robot 7 in step S204, and conveyed outside the injection molding machine 2. In step S205, fixed platen 61 and moveable platen 62 move in a direction to close the mold 100A/100B, but the mold 100A/100B is not completely closed and remains slightly open.

The length of a gap between different molds ranges from an order of several ten micrometers to several hundred micrometers. The length of the gap can change based on the molding material. Step S205 can be performed via a two-sub-step process, where in the first sub-step, the movable mold 102 is moved relatively fast to a predetermined position near the closed position. In the second sub-step, the movable mold 102 is moved relatively slow from the certain position to a desired position to create the desired gap between the fixed mold 101 and the movable mold 102. In the second sub-step, the movable mold 102 can be subjected to a feedback control using a sensor (not illustrated) dedicated to the precise measurement of the length of the gap.

The length of the gap should not be such that the melted material enters the gap while the melted material is being injected. In order words, the gap between the moveable mold 102 and the fixed mold 102 of the mold 100A/100B should be small enough that the melted material does not get into the gap. The length of the gap for a mold is typically determined via an experimental process, which takes into consideration various parameters including a type of material and pressure applied to the mold.

In step S206, the injecting apparatus 5 is driven to fill molten resin into a cavity in the mold 100A from the nozzle 52. In step S207, clamping of the mold 100A by the fixed platen 61 and the movable platen 62 is performed by driving the motor 66 to drive the toggle mechanism 65. In step S208, the cylinder 51 dwells in the mold 100A at a high pressure in order to compensate for a volume decrease due to resin solidifying. In step S209, locking of the mold 100A by the fixing mechanism 610 is released. This results in removal of the clamping force, and the movable platen 62 is slightly separated from the fixed platen 61. In step S210, after a delay of a predetermined time from step S209, the motor 66 is driven to drive the toggle mechanism 65. That is, the fixed platen 61 and the moveable platen 62 move to a retreat position where they do not contact with the mold 100A/100B. This movement of the fixed platen 61 and the moveable platen 62 results in formation of a space between them for alternating (changing) the molds 100A and 100B.

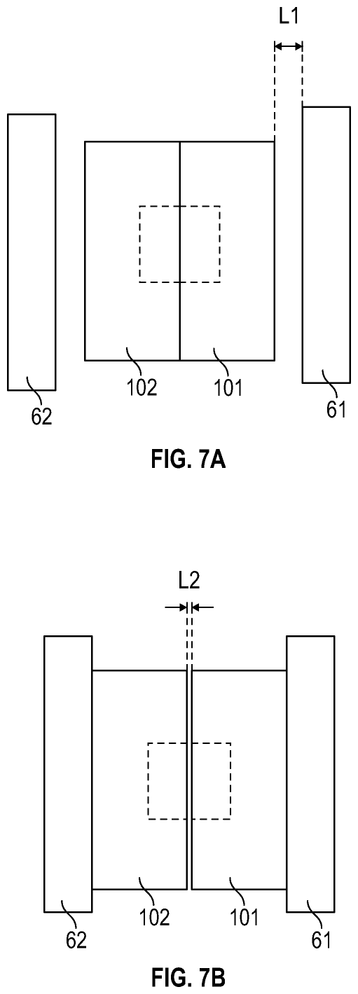

In step S210, the length of a gap between the mold and the platen ranges from an order of several millimeters to several hundred centimeters. This gap is illustrated as L1 in FIG. 7A. As described above, in step S205, the length of the gap between the molds ranges from an order of several ten micrometers to several hundred micrometers. This gap is illustrated as L2 in FIG. 7B.

After step S209, the mold 100A/100B is ejected from the molding operation position 11 to the conveying machine 3A/3B, where the mold 100A/100B is cooled as described above. The time period of the cooling process can vary depending on a mold or a parameter set at launch of a specific injection molding process.

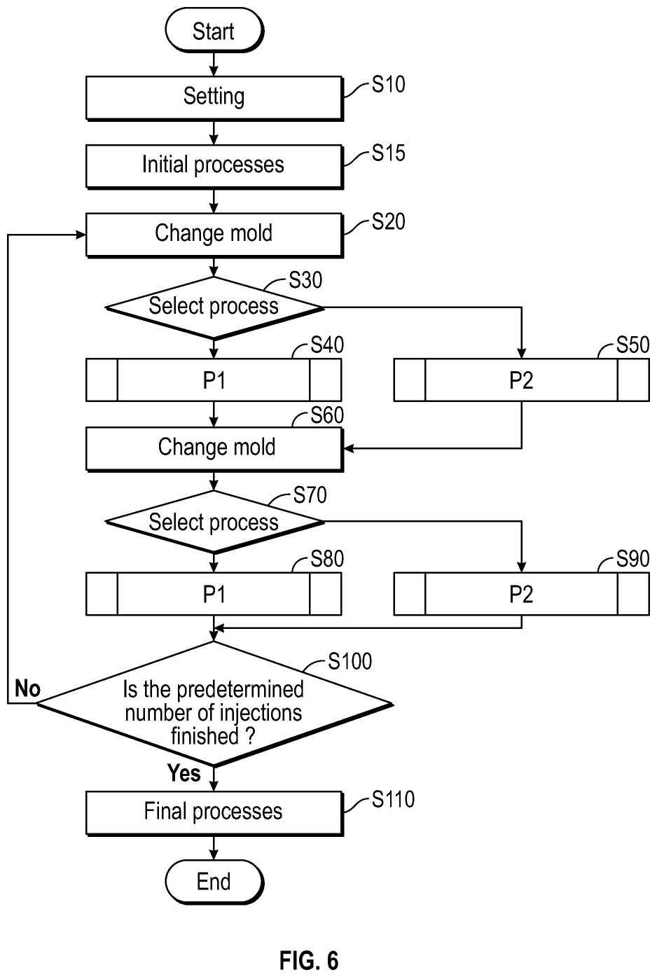

FIG. 6 is a flowchart illustrating an example of processing of a molding operation while alternating molds executed by the controller 41. In the following example, a case in which a molding operation is performed while alternating the molds 100A and 100B is envisioned, i.e., molding using mold 100A→molding using mold 100B→molding using mold 100A, etc.

An initial setting is performed in step S10 of FIG. 6. Here, for each of the molds 100A and 100B, operation conditions of the injecting apparatus 5 and the clamping apparatus 6 are registered.

The operation conditions include, for example, the process of molding (molding method), the amount of resin that is injected at one time, the temperature, the injection speed, the clamping force, the initial value of the position of the movable platen 63 in relation to the tie-bars 64, etc. The operation conditions can differ even when the mold 100A and the mold 100B are the same. The operation conditions are stored in a memory of control apparatus 4.

In step S15, as initial processes, the injection processes are performed for both the molds 100A and 100B. In the present example, the injection process is performed with the mold 100A and then with the mold 100B. First, the conveying machine 3A moves the mold 100A into the molding operation position 11. If it is set that the Molding Process P1 is set for the mold 100A, then the injection molding machine 2 performs the processes of steps S101, S102 and S105-109. If it is set that the Molding Process P2 is set for the mold 100A, then the injection molding machine 2 performs the processes of steps S201, S202 and S205-S209.

The conveying machine 3A moves the mold 100A out of the molding operation position 11 and the conveying machine 3B moves the mold 100B into the molding operation position 11. If it is set to perform Molding Process P1 for the mold 100B, the injection molding machine 2 performs the processes of steps S101, S102 and S105-109. If it is set to perform the Molding Process P2 for the mold 100B, the injection molding machine 2 performs the processes of steps S201, S202 and S205-S209 for the mold 100B.

In step S20, the mold 100B is unloaded and the mold 100A is loaded. If the mold 100B is not at the injection molding machine 2, only loading of the mold 100A is performed. In step S30, the controller 41 selects the molding process for the mold 100A is selected based on the information stored in the memory. If the Molding Process P1 is set for the mold 100A, the process proceeds to step S40. If the Molding Process P2 is set for the mold 100A, the process proceeds to step S50.

After completing step S40 or step S50, in step S60, unloading of the mold 100A and loading of the mold 100B is performed. In step S70, the controller 41 selects the molding process for the mold 100B based on the information stored in the memory. If the Molding Process P1 is set for the mold 100B, the process proceeds to step S80. If the Molding Process P2 is set for the mold 100B, the process proceeds to step S90. In step S100, the controller 41 determines whether a predetermined number of injections (number of molded parts produced) have finished. If the predetermined number of injections have not been finished, the controller 41 returns to step S20, and production of the molded parts is repeated.

If the predetermined number of injections has been completed, the process proceeds to step S110, in which the molded parts are ejected from both the mold 100A and the mold 100B. For example, the conveying machine 3A moves the mold 100A) located at the molding operation position 11 in step S60 out of the molding operation position 11. The conveying machine 3B then moves the mold 100B into the molding operation position 11. The mold 100B has previously been cooled on the conveying machine 3B, while the Molding Process P1 or Molding Process P2 was performed for the mold 100A in either steps S40 or S50. The injection molding machine 2 performs either the processes of steps S101-S104 and S108 or the processes of steps S201-S204 and 5208 for the mold 100B. If it is set that the Molding Process P1 is performed for the mold 100B, the processes of S101-S104 and S108 are performed. If it is set that the Molding Process P2 is performed for the mold 100B, the process of steps S201-S204 and S208 are performed.

The conveying machine 3B moves the mold 100B out of the molding operation 11, and then the conveying machine 3A moves the mold 100A into the molding operation position 11. Because the mold 100B skips some of the processes, the period of time in which the mold 100A has been cooling on the conveying machine 3A is shorter than the normal period of time. Therefore, the cooling of the mold 100A may not have been completed at the time the mold 100A is moved into the molding operation position 11. If the cooling is not completed, the injection molding machine 2 waits for the cooling process to be completed.

After the cooling process is completed, the injection molding machine 2 performs the processes of steps S101-S104 and S108 if it is set that the Molding Process P1 is performed for the mold 100A. The injection molding machine 2 performs the processes of steps S201-S204 and S208 if it is set that the Molding Process P2 is performed for the mold 100A. T The mold 100A is then moved from the molding operation position 11 and the process ends.

In the above-described embodiment, both the conveying machine 3A and the conveying machine 3B include an actuator. According to another exemplary embodiment, an actuator is only provided with either the conveying machine 3A or the conveying machine 3B, In a case where only the conveying machine 3A includes an actuator, the mold 100A and the mold 100B are connected via a metal connection part, which enables the single actuator to move both the mold 100A and 100B.

According to the above-described injection molding system, compression molding can be performed while alternating (changing) molds. This enables productivity improvement.

According to the above-described injection molding system, the molding process can be changed for each mold when performing the injection molding while alternating (changing) the multiple molds.

In the above-described embodiments, clamping, injection/dwelling, opening, and ejection are performed in the state where the mold is at the molding operation position 11 This is not seen to be limiting. In another exemplary embodiment, not all the processes need be performed at the molding operation position 11. Some of the processes can be performed at a position different from the molding operation position 11.

In the above-described embodiments, the cooling process is performed in the state where the mold is on the conveying machines. This is not seen to be limiting. In another exemplary embodiment, the cooling process need not be performed on the conveying machines. The cooling process can be performed at a position where the mold does not contact with the fixed platen and the movable platen. For example, the cooling process can be performed when a part of the mold is in the injection molding machine and part of the mold is outside the injection molding machine.

In another exemplary embodiment, in a configuration that a part of either of the conveying machines is located in the injection molding machine 2, the cooling process can be performed in a state where a part of the mold is in the injection molding machine 2 and a part of the mold is on either of the conveying machines.

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Combinations of any exemplary embodiments disclosed above are also included as embodiments of the present disclosure. While the above-described exemplary embodiments discuss illustrative embodiments, these embodiments are not seen to be limiting.

What is claimed is:

1. A method for manufacturing a molded part with an injection molding machine and a conveying apparatus while changing between multiple molds, the method comprising:
conveying a first mold to a molding operation position in the injection molding machine;
securing the first mold at the molding operation position with a platen;
fixing the platen to the first mold;
opening the first mold;
ejecting a molded part from the first mold;
placing the first mold into a state where the first mold is slightly opened;
injecting a molding material into the first mold;
applying pressure to the first mold by closing the slight opening of the first mold;
releasing the platen from the first mold;
conveying the first mold from the molding operation position to the conveying apparatus; and
cooling the first mold on the conveying apparatus.

2. The method according to claim 1, wherein the first mold includes a fixed mold and a movable mold, wherein a length of a gap between the fixed mold and the movable mold when placing the first mold in a state where the first mold is slightly open is shorter than a length of a gap between the first mold and the platen when the first mold is conveyed to the conveying apparatus.

3. The method according to claim 1, further comprising:
conveying a second mold to the molding operation position;
securing the second mold with the platen at the molding operation position;
fixing the platen to the second mold;
opening the second mold;
ejecting a molded part from the second mold;
placing the second mold into a state where the second mold is slightly opened;
injecting a molding material into the second mold;
closing the second mold;
applying pressure to the second mold;
releasing the platen from the second mold;
conveying the second mold from the molding operation position to the conveying apparatus; and
cooling the second mold on the conveying apparatus.

4. The method according to claim 1, wherein the conveying apparatus includes a first conveying machine and a second conveying machine, and
wherein the first mold is cooled on the first conveying machine and a second mold is cooled on the second conveying machine.

5. An injection molding system comprising:
an injection molding machine;
a conveying apparatus configured to convey a mold to the injection molding machine; and
a control apparatus configured to control the injection molding machine and the conveying apparatus,
wherein the improvement to the injection molding system includes:
the control apparatus executing a first molding process and a second molding process,
wherein the first molding process includes injecting the mold where the mold is slightly opened, closing the mold, and cooling the mold on the conveying apparatus, and
wherein the second molding process includes injecting the mold when the mold is closed, and cooling the mold on the conveying apparatus.

6. A method of an injection molding system comprising:
setting a molding condition for a first mold and a second mold respectively,
wherein the molding condition is set to a first molding process or a second molding process,
wherein the first molding process includes injecting a mold when the mold is slightly opened, closing the mold, and cooling the mold on a conveying apparatus, and
wherein the second molding process includes injecting a mold when the mold is closed, and cooling the mold on the conveying apparatus.
